(19) United States
(12) Patent Application Publication
(10) Pub. No.: US 2006/0060667 A1
(43) Pub. Date: Mar. 23, 2006

(54) Sprinkler

(75) Inventor: Kuan-Hsiung Wang, Changhua (TW)

Correspondence Address: BACON & THOMAS, PLLC, 625 SLATERS LANE, FOURTH FLOOR, ALEXANDRIA, VA, 22314, US

(73) Assignee: Hsin Yuirs Industrial Co., Ltd., Changhua (TW)

(21) Appl. No.: 10/945,910

(22) Filed: Sep. 22, 2004

(51) Int. Cl. B05B 3/00

(52) U.S. Cl. 239/246; 239/240; 239/243; 239/247; 239/249

(57) ABSTRACT

A sprinkler comprises a housing having an inlet, three apertures and a through hole. A transmission device has a fan wheel and a decreasing device mounted in the housing. A fixed base is mounted on a top of the housing, which has an axial hole communicated with the through hole and three lateral holes communicated with the axis hole. A piston is received in the axial hole of the fixed base, which is connected to the decreasing device to be driven for reciprocation. Three jet fan are received in the lateral hole and pivoted on the fixed base, each of which has a channel with an inlet and an outlet. The jet fans are driven by the reciprocation of the piston for swing. Three hose are connected to the apertures of the housing and the inlets of the jet fan respectively.

### BACKGROUND OF THE INVENTION

1. Field of the Invention

The present invention relates generally to a gardening tool, and more particularly to a sprinkler, which sprinkles water for a greater area.

2. Description of the Related Art

FIG. 1 shows a conventional sprinkler 1, which has a frame 2 and a rotary base 3. The rotary base 3 has an elongated barrel mounted on side frames 2a of the frame 2 for free rotation in a predetermined range. The rotary base 3 is issued with water therein and scatters it out via outlets 3a on a top of the rotary base 3. The range of the rotation of the rotary base 3 decides the area of sprinkling. FIG. 2 shows the area that the sprinkler 1 sprinkles. The area A and B only located at opposite sides of the rotary base 3. Water can not reach to the other place.

As shown in FIG. 3, another conventional sprinkler 5 has a rotary fan 6. Water flows along the fan 6 and the rotation of the fan 6 sprinkles water to various orientations. As shown in FIG. 4, there still are some places C that the sprinkler 5 can not sprinkle water to.

### SUMMARY OF THE INVENTION

The primary objective of the present invention is to provide a sprinkler, which can sprinkle water to a greater area.

The secondary objective of the present invention is to provide a sprinkler, which can adjust the angle of water jet to change the place of sprinkling.

According to the objectives of the present invention, a sprinkler comprises a housing having an inlet, at least an aperture and a through hole. A transmission device has a fan wheel mounted in the housing for rotation and a decreasing device. The fan wheel is located at where adjacent to the inlet to drive the decreasing device working. A fixed base is mounted on a top of the housing, which has an axial hole communicated with the through hole of the housing and at least a lateral hole communicated with the axis hole. A piston is received in the axial hole of the fixed base, which is connected to the decreasing device to be driven for reciprocation. At least a jet fan is received in the lateral hole and pivoted on the fixed base, which has a channel with an inlet and an outlet, wherein the jet fan is driven by the reciprocation of the piston for swing, and at least a hose is connected to the aperture of the housing and the inlet of the channel of the jet fan respectively.

### BRIEF DESCRIPTION OF THE DRAWINGS

FIG. 1 is a perspective view of a conventional sprinkler;

FIG. 2 is a perspective view, showing the area of the conventional sprinkler of FIG. 1 scattering water to;

FIG. 3 is a perspective view of another conventional sprinkler;

FIG. 4 is a perspective view, showing the area of the conventional sprinkler of FIG. 3 scattering water to;

FIG. 5 is a perspective view of a first preferred embodiment of the present invention;

FIG. 6 is a sectional view of a front of the first preferred embodiment of the present invention;

FIG. 7 is a sectional view of a rear of the first preferred embodiment of the present invention;

FIG. 8 is an exploded view of the jet fan of the first preferred embodiment of the present invention;

FIG. 9 and FIG. 10 are sectional views of the first preferred embodiment of the present invention, showing the angle of the jet fan being changed;

FIG. 11, FIG. 12 and FIG. 13 are perspective views, showing the area of the sprinkler of the first preferred embodiment of the present invention scattering water to;

FIG. 14 is an sectional view of a second preferred embodiment of the present invention, showing the decreasing device and the piston, and

FIG. 15 and FIG. 16 are perspective view of the second preferred embodiment of the present invention, showing the action of the jet fan.

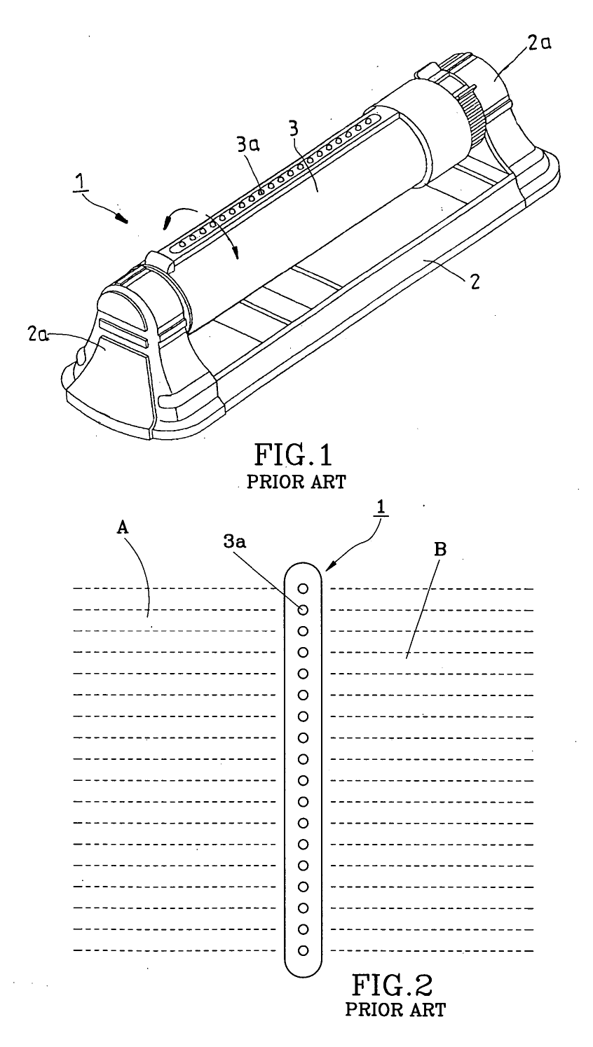

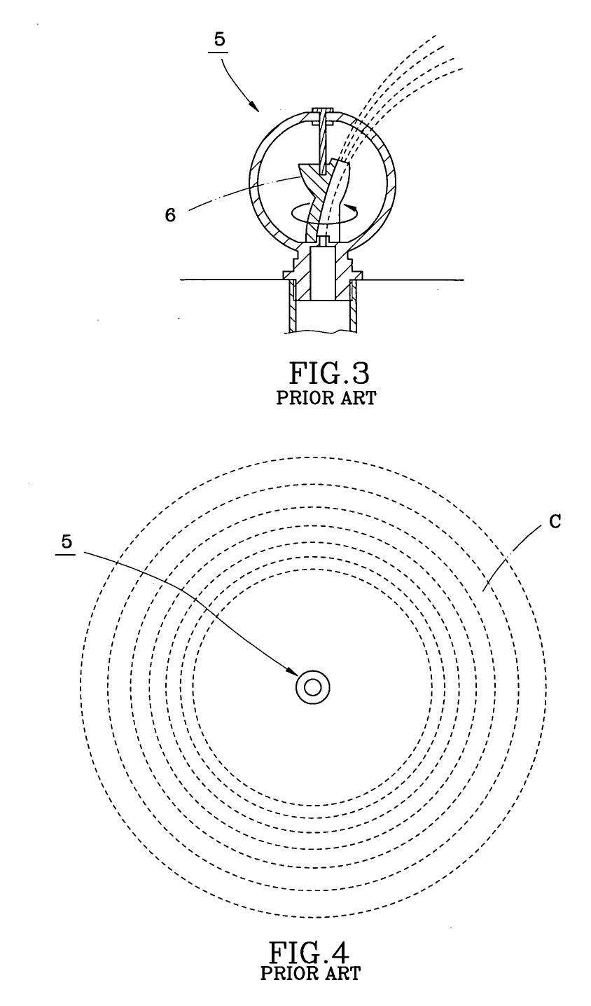

### DETAILED DESCRIPTION OF THE INVENTION

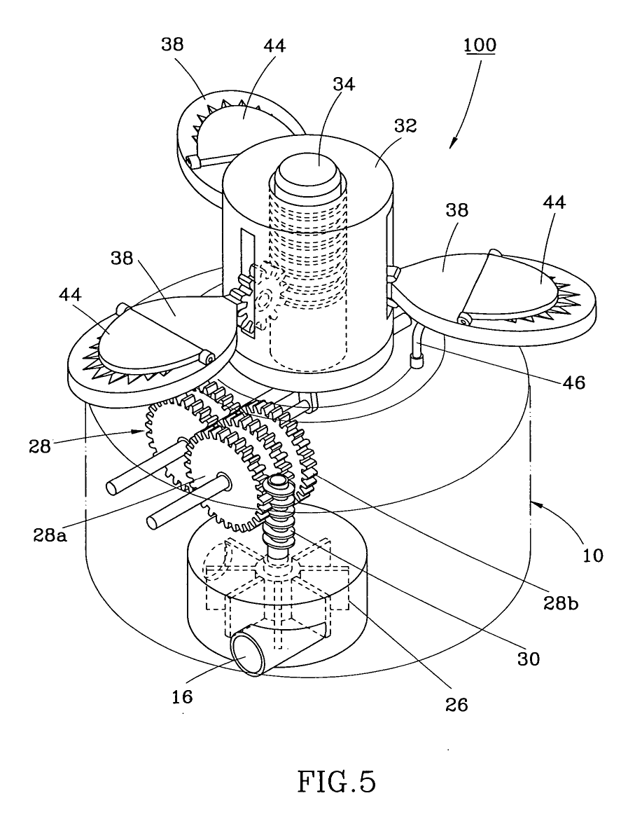

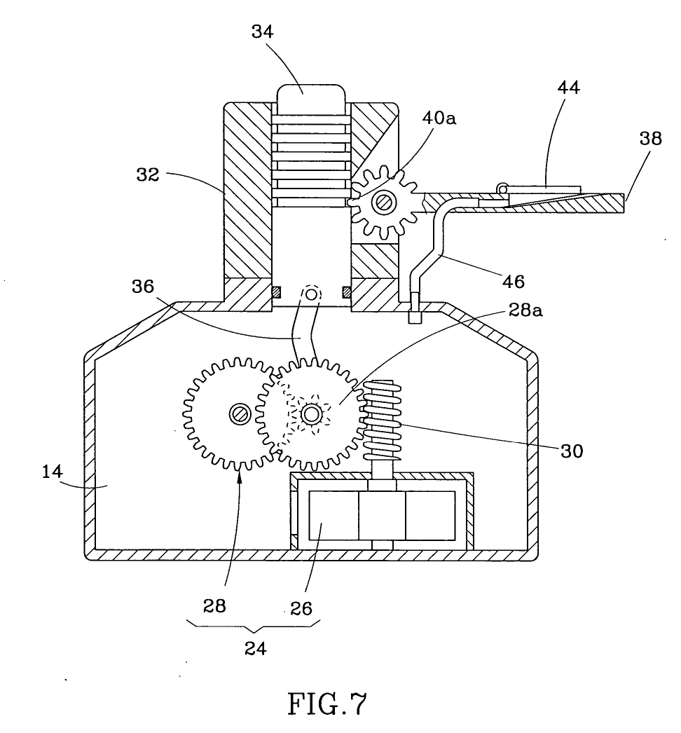

As shown in FIG. 5 to FIG. 7, the first preferred embodiment of the present invention provides a sprinkler 100 comprising:

A housing 10 has a first chamber 12, a second chamber 14, an inlet 16 communicated with the first chamber 12, a through hole 18 and three apertures 20 around the through hole 18. The through hole 18 and the apertures 20 are communicated with the second chamber 14. The first chamber 12 is isolated from the second chamber 14 via a wall and the wall has plural holes 22 to communicate the chambers 12 and 14.

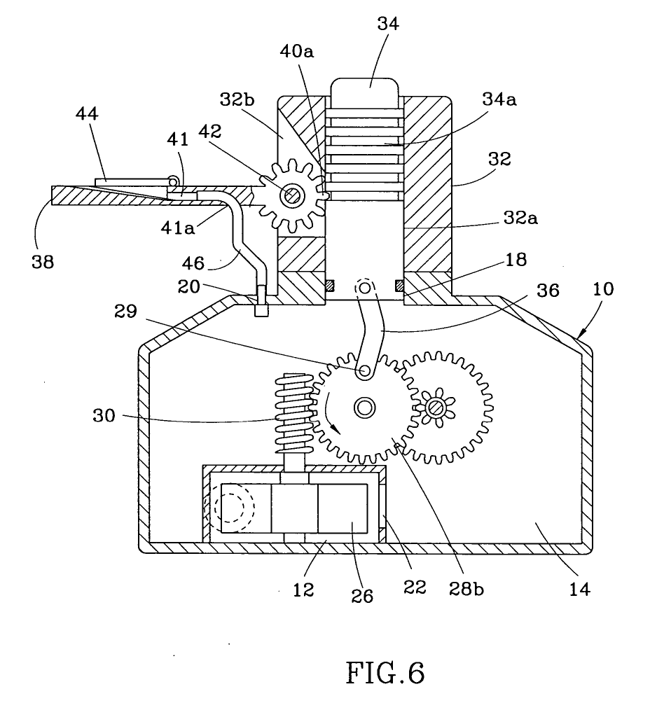

A transmission device 24 has a fan wheel 26 and a decreasing device 28. The fan wheel 26 is mounted in the first chamber 12 for free rotation. A worm shaft 30 has an end mounted to the fan wheel 26 and has the other end passing through the wall and reaching in the second chamber 14. The decreasing device 28 is mounted in the second chamber 14 and has plural gears in mesh. A gear 28a is meshed with the worm shaft 30 and a gear 28b is mounted with a post 29 (referring to FIG. 6). The post 29 is distal to a center of rotation of the gear 28b.

A fixed base 32 is mounted on the top of the housing 10, which has an axial hole 32a aligned with the through hole 18 and three lateral holes 32b on a circumference and communicated with the axial hole 32a.

A piston 34 is received in the axial hole 32a of the fixed base 32, on which plural slots 34 are provided.

A linkage 36 pivots its opposite ends on the post 29 of the decreasing device 29 and the piston 34.

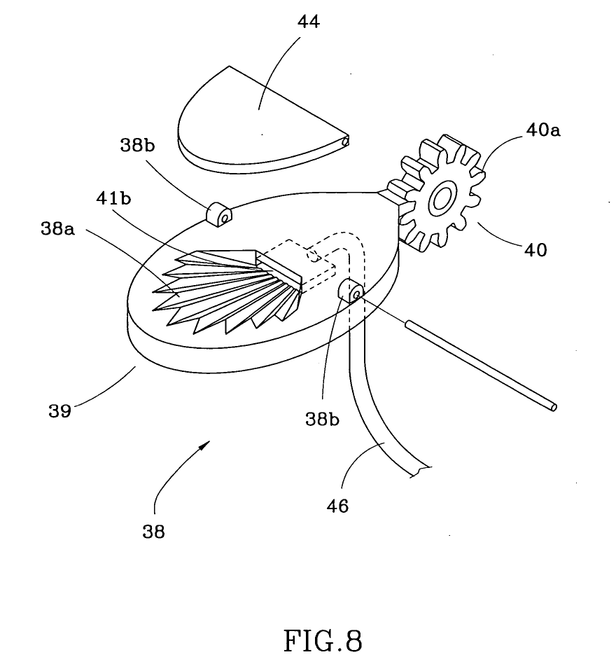

Three jet fans 38 are received in the lateral holes 32b of the fixed base 32 and pivoted on the fixed base 32 via pins 42 respectively. As shown in FIG. 8, the jet fan 38 has a distal end 39, a proximal end 40 and a channel 41. A gear with plural teeth 40a is mounted on the proximal end 40 of the jet fan 38 to be meshed with the slots 34a of the piston 34 (referring to FIG. 6). The channel 41 has an inlet 41a and an outlet 41b. The jet fan 38 has a fan-shaped guiding portion 38a on a top thereof in front of the outlet 41b of the channel 41. The jet fan 38 further has two protrusions 38b on the top thereof.

The jet fans 38 each are mounted with a plate 44. The plates 44 are pivoted on the protrusions 38b respectively to swing relative to the jet fans 38.

Three hoses 46 are connected to the apertures 20 of the housing 10 and the inlet 41a of the channel 41 of the jet fans 38 respectively.

Water is issued into the first chamber 12 via the inlet 16, and then flows to the second chamber 14 via the holes 22, apertures 20 and the hoses 46, at least, water is come out from the outlets 41b for sprinkling.

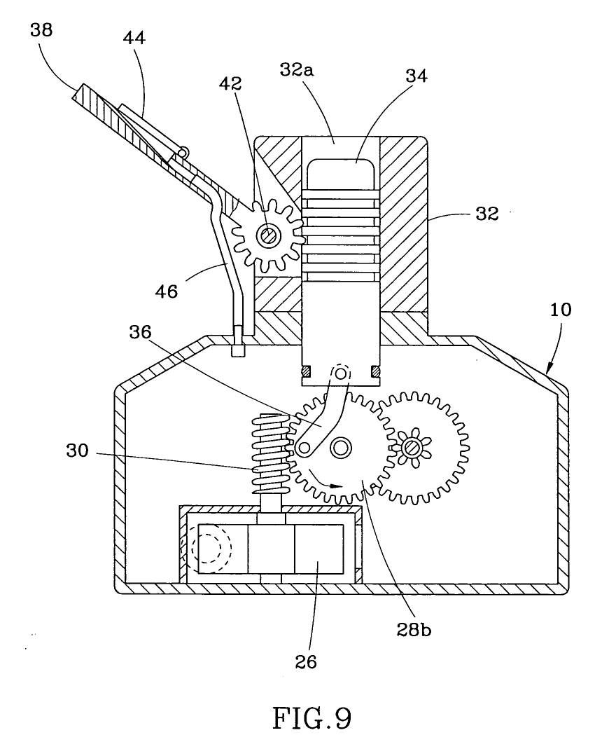

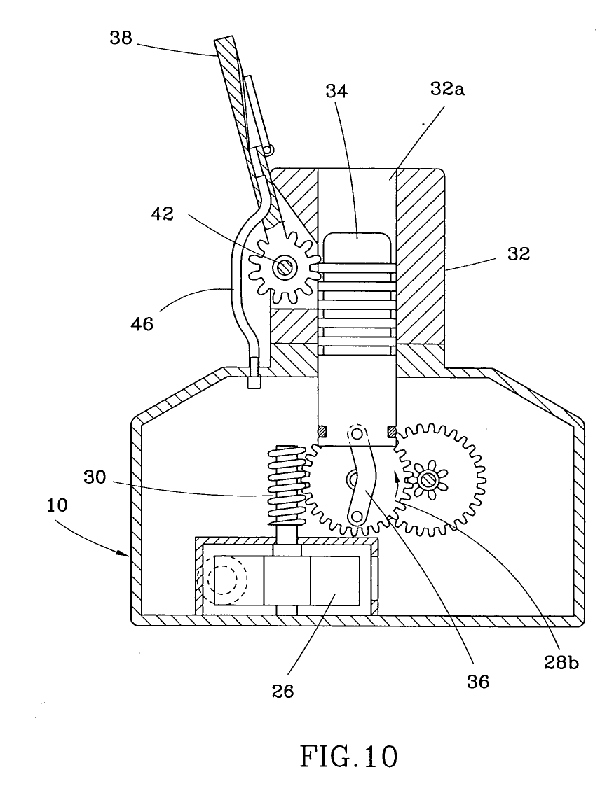

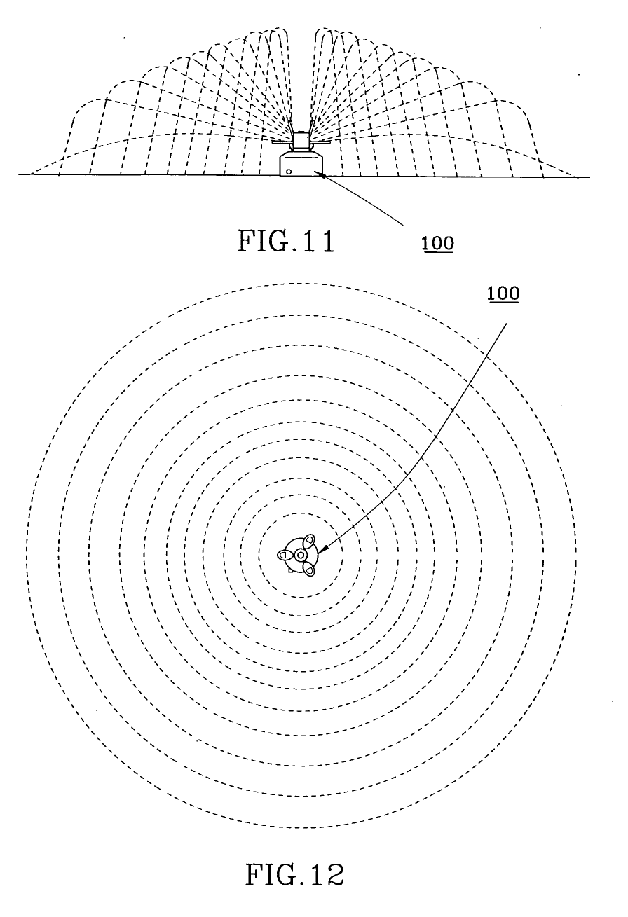

The fan wheel 26 is rushed by the water jet for rotation, in the meantime, the worm shaft 30 is rotated and drives the gears of the decreasing device 28 turning. The post 29 serves as a crank to reciprocate the piston 34 slowly. The mesh of the slots 34a of the piston 34 and the teeth 40a of the jet fans 30 drives the jet fans 30 swinging (referring to FIG. 6, FIG. 9 and FIG. 10) while the piston 34 is reciprocating. The swinging of the jet fans 30 changes the distance of the water sprinkling (referring to FIG. 11). The fan wheel 26 are mounted on the circumference of the fixed base 32 in equal intervals and the guiding portions 38 have fan shapes that makes water sprinkling to everywhere as shown in FIG. 12.

In addition, the sprinkler 100 of the present invention can have the plates 44 swinging proximal to the jet fans 38, as shown in FIG. 13, such that water sprinkles in a shorter distance.

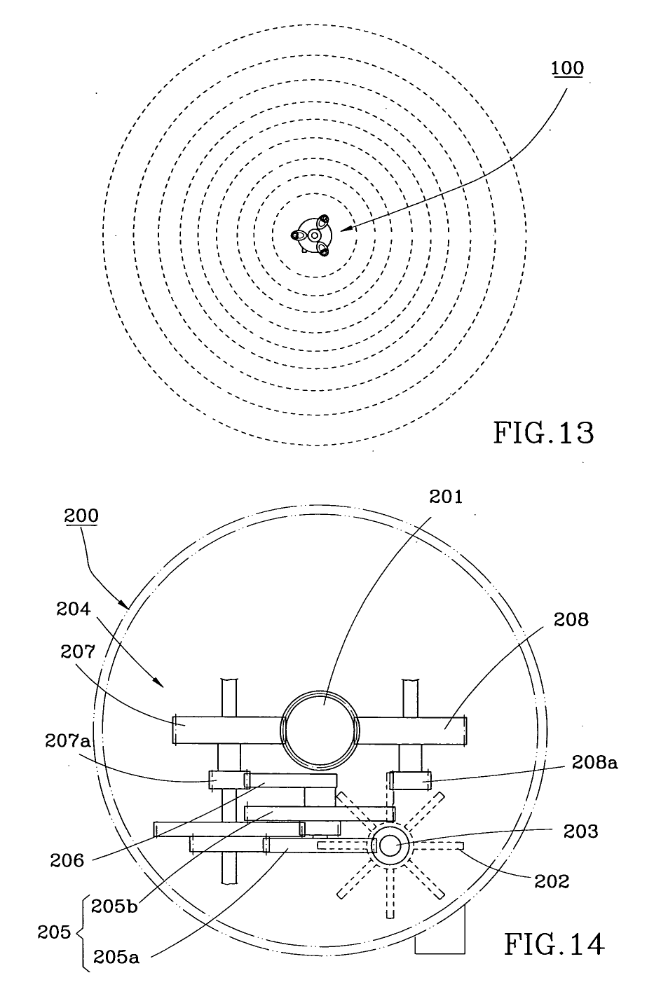

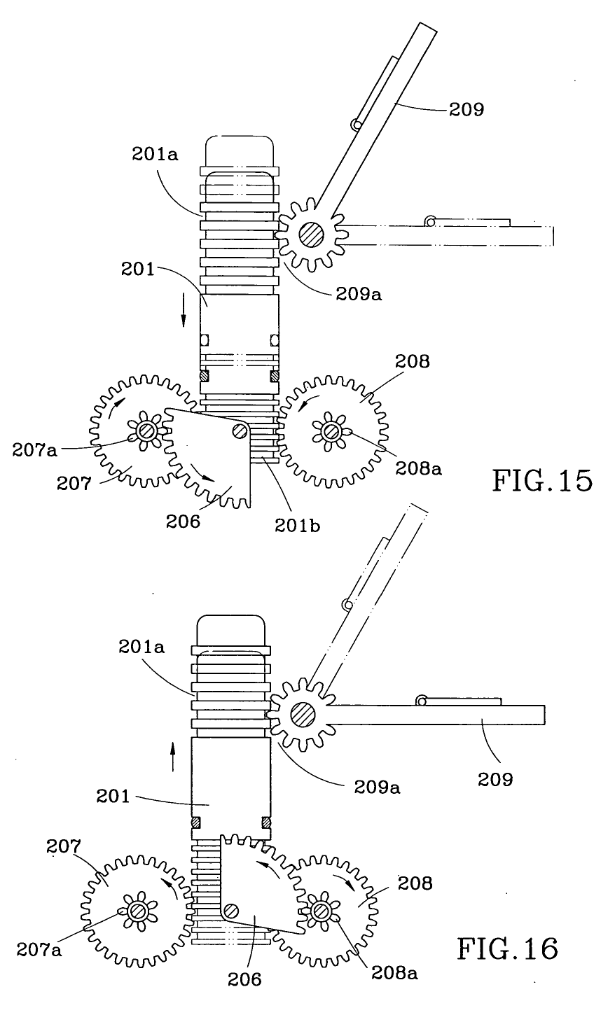

As shown in FIG. 14 and FIG. 15, a sprinkler 200 of the second preferred embodiment of the present invention, which is similar to the sprinkler 100 of the first preferred embodiment, provides a fan wheel 202, a worm shaft 203 connected to the fan wheel 202 and a decreasing device 204 to reciprocate a piston 201. The decreasing device 204 has plural gears 205, a sector gear 206 and two driving gears 207 and 208. The worm shaft 203 is meshed with the gear 205a and the gear 205b rotates the gear 206. As shown in FIG. 15, the piston 201 has plural slots 201a and 201b at an upper section and a lower section thereof. The slots 201a are meshed with proximal ends 209a of jet fans 209 and the slots 201b are meshed with the driving gears 207 and 208. The driving gears 207 and 208 each have a driven gear 207a and 208a connected to the axle respectively.

As shown in FIG. 15, while the gear 206 rotates to be meshed with the driven gear 207a of the driving gear 207, the driving gear 207 is rotated to move the piston 201 downwardly. On the contrary, while the gear 206 rotates to be meshed with the driven gear 208a of the driving gear 207, the driving gear 208 is rotated to move the piston 201 upwardly, as shown in FIG. 16. The reciprocation of the piston 201 changes the angles of elevation of the jet fans 209 to adjust the distance of water sprinkling.

What is claimed is:

1. A sprinkler, comprising:
a housing having an inlet, at least an aperture and a through hole;
a transmission device having a fan wheel mounted in the housing for rotation and a decreasing device, wherein the fan wheel is located at where adjacent to the inlet to drive the decreasing device working;
a fixed base mounted on a top of the housing, which has an axial hole communicated with the through hole of the housing and at least a lateral hole communicated with the axis hole;
a piston received in the axial hole of the fixed base, which is connected to the decreasing device to be driven for reciprocation;
at least a jet fan received in the lateral hole and pivoted on the fixed base, which has a channel with an inlet and an outlet, wherein the jet fan is driven by the reciprocation of the piston for swing, and
at least a hose connected to the aperture of the housing and the inlet of the channel of the jet fan respectively.

2. The sprinkler as defined in claim 1, wherein the housing has a first chamber and a second chamber, which the chambers are isolated from each other via a wall and the wall has at least a hole to communicate the chambers, and the inlet is communicated with the first chamber and the aperture and the through hole are communicated with the second chamber and the fan wheel is mounted in the first chamber and the decreasing device is mounted in the second chamber.

3. The sprinkler as defined in claim 2, wherein the fan wheel has a worm shaft, which is received in the second chamber, and the decreasing device has a plurality of gears, wherein one of the gear of the decreasing device is meshed with the worm shaft and one of the gear has a post thereon distal to a center of rotation of the gear and the post and a linkage is pivoted on the piston and the post.

4. The sprinkler as defined in claim 3, wherein the housing has three of the apertures, the fixed base has three of the lateral holes and three of the jet fans in the lateral holes respectively and each of the jet fans have teeth at a proximal end to be meshed with slots on the piston and three of the hoses are provided to be connected to the apertures and the inlets of the jet fans respectively.

5. The sprinkler as defined in claim 4, wherein each of the jet fans have a sector-shaped guiding portion in front of the outlet.

6. The sprinkler as defined in claim 5, wherein each of the jet fans are provided with a plate on the guiding portion and the plate is pivoted on the jet fan for adjustment of a gap between the plate and the guiding portion.

7. The sprinkler as defined in claim 2, wherein the piston has a plurality of slots at a lower section thereof, the fan wheel has a worm shaft and the decreasing device has a plurality of gears, a sector gear and two driving gears, wherein one of the gears is meshed with the worm shaft and one of the gears is connected to the sector gear to rotate it and the driving gear are meshed with the slots at the lower section of the piston and the driving gears each have a driven gear to be meshed with the sector gear respectively, while the sector gear rotates.

8. The sprinkler as defined in claim 7, wherein each of the jet fans have teeth at a proximal end there of and the piston has a plurality of slots at an upper section thereof to be meshed with the teeth of the jet fans.
